(19) United States
(12) Patent Application Publication
(10) Pub. No.: US 2012/0097346 A1
(43) Pub. Date: Apr. 26, 2012

(54) Bottom Hem Bar

(76) Inventor: Philip Ng, Thornhill (CA)

(21) Appl. No.: 12/910,012

(22) Filed: Oct. 22, 2010

(51) Int. Cl. E06B 9/42

(52) U.S. Cl. 160/264

(57) ABSTRACT

There is disclosed a bottom bar for attachment to a lower edge of a window blind. The bottom bar includes an elongated tube having a length equal to the width of the window blind. The elongated tube has first and second side walls separated by a space and an elongated slit extending along the entire elongated tube. The elongated slit communicates with the space. The elongated slit has a width. The bottom bar further includes an elongated flat member having an axis and a length equal to the width of the blind. The flat member has opposite first and second side edges, a width between the first and second side edges, and a thickness, the thickness of the elongated flat member being less than the width of the elongated slit. The width of the elongated flat member is dimensioned to be greater than the width of the slit while permitting the elongated flat member to fit entirely within the space. The first and second side walls and the width of the elongated flat member are configured such that the elongated flat member cannot rotate about its axis when the elongated flat member is within the space. The lower edge of the window blind is secured to the bottom bar by being wrapped around the elongated flat member.

### FIELD OF THE INVENTION

The invention relates generally to bottom bars for blinds, particularly for use with roller blinds.

### BACKGROUND OF THE INVENTION

Window blinds in general, and roller blinds in particular, include a long fabric blind which is gathered in a roller positioned at or near the top of the window frame. The blind hangs down from the roller by the force of gravity. The lower edge of the blind is generally weighed down with an elongated bar which extends the entire width of the blind. This elongated bar, usually referred to as a bottom bar, serves three useful purposes, namely as a weight to weigh down the lower edge of the blind, as a dressing to improve the appearance of the lower edge of the bar, and as a means to allow a user to pull down the blind by grasping the bottom bar and pulling down. The bottom bar generally consists of an elongated hollow tube of some sort having an elongated slit to permit the edge of the blind to pass into the tube's interior. The bottom bar is mounted to the lower edge of the blind by a variety of methods. Since the attachment must be secure, a common method is to rivet a series of lugs onto the bottom edge of the blind and then slide the bottom bar over the lugs with the blind exiting the elongated slit in the bottom bar. While secure, this method leads to an unsightly “scalloping” of the bottom edge of the blind where the lugs are riveted. Therefore, an improved method of securely mounting the bottom bar to the bottom edge of the blind is required.

### SUMMARY OF THE INVENTION

In accordance with one aspect of the present invention, there is provided a bottom bar for attachment to a lower edge of a window blind having a width. The bottom bar made in accordance with this aspect of the invention includes an elongated tube having a length equal to the width of the window blind. The elongated tube has first and second side walls separated by a space and an elongated slit extending along the entire elongated tube. The elongated slit communicates with the space. The elongated slit has a width. The bottom bar further includes an elongated flat member having an axis and a length equal to the width of the blind. The flat member has opposite first and second side edges, a width between the first and second side edges, and a thickness, the thickness of the elongated flat member being less than the width of the elongated slit. The width of the elongated flat member is dimensioned to be greater than the width of the slit while permitting the elongated flat member to fit entirely within the space. The first and second side walls and the width of the elongated flat member are configured such that the elongated flat member cannot rotate about its axis when the elongated flat member is within the space. The lower edge of the window blind is secured to the bottom bar by being wrapped around the elongated flat member.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a perspective view of a bottom bar made in accordance with the present invention coupled to the bottom edge of a window blind.

FIG. 2 is a cross sectional view of the bottom bar shown in FIG. 1.

FIG. 3 is a perspective view of the flat member portion of the bottom bar shown in FIG. 1.

In the drawings like characters of reference indicate corresponding parts in the different figures.

### DETAILED DESCRIPTION OF THE INVENTION

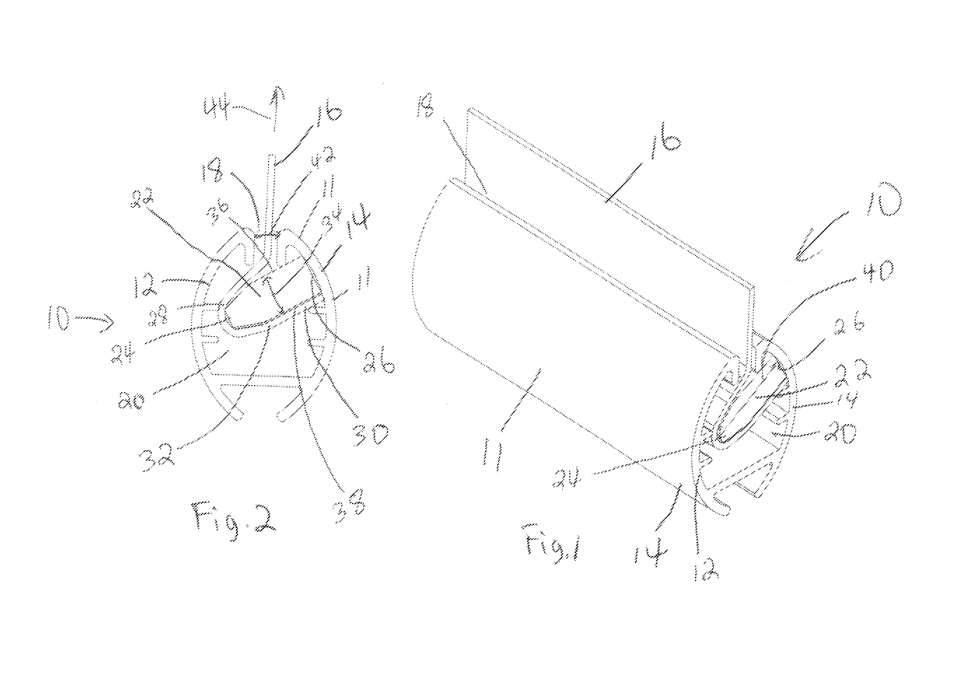

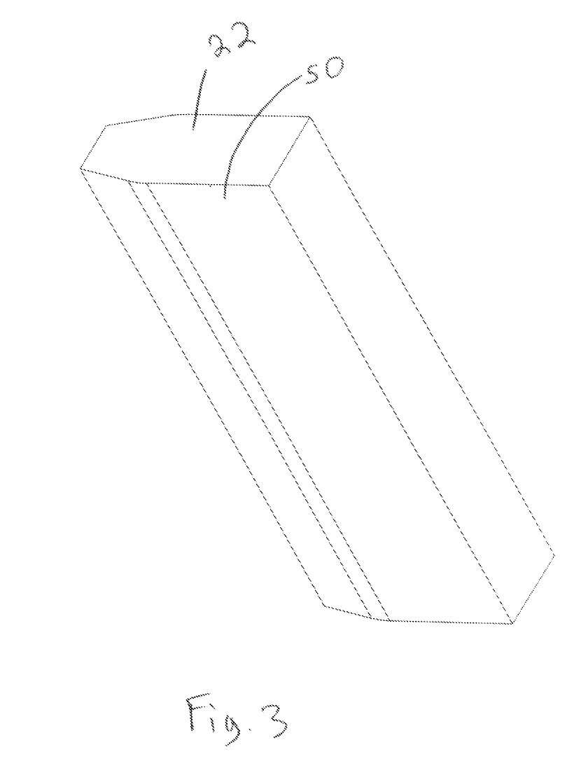

Referring to FIGS. 1 and 2, a bottom or hem bar made in accordance with one aspect of the present invention is shown generally as item 10 and includes an elongated tube 11 and elongated flat member 22. Elongated tube 11 has opposite side walls 12 and 14 separated by space 20. Elongated slit 18 is formed on tube 11 and extends along the entire length of tube 11. Elongated slit 18 has a width 42. Elongated flat member 22 has opposite side edges 24 and 26, opposite sides 36 and 38, width 40 as measured between opposite side edges 24 and 26 and thickness 34 as measured between opposite sides 36 and 38. Slit 18 is dimensioned to receive lower end 16 of the fabric blind. Portion 32 of fabric blind end 16 is wrapped around elongated flat member 22. Slit 18 and space 20 are dimensioned such that elongated flat member 22 with fabric portion 32 wrapped around it can be inserted into space 20 through slit 18.

Thickness 34 of elongated flat member 22 is selected to be slightly narrower than width 42 of slit 18, even when the elongated member is wrapped by portion 32 of blind end 16.

However, if tube 11 is made of a resilient material such as plastic, it is possible to insert elongated flat member 22 into space 20 via slit 18 by forcing edge 24 through the slit with sufficient force to cause walls 12 and 14 to separate slightly. Edge 24 is preferably tapered to permit easy insertion through slit 18. Width 40 of elongated flat member 22 is selected such that it is much greater than width 42 of slit 18, preventing the elongated member from being removed from elongated tube 11 after the flat member has been inserted. Furthermore, space 20, walls 12 and 14 and the width 40 of elongated flat member 22 are selected such that the elongated flat member cannot rotate about its axis while contained in space 20. Walls 12 and 14 could be provided with internally projecting ridges or bumps to prevent the rotation of elongated flat member 22; however, simply providing tube 11 with an elliptical (or non-circular) profile will be sufficient to prevent elongated flat member 22 from rotating about its axis after it has been inserted.

In order to ensure easy mounting, portion 32 of fabric blind 16 can be adhered to side 38 of the elongated flat member, preferably by a strip of double sided adhesive tape (see FIG. 3). When portion 32 is wrapped around elongated flat member 22 and then inserted into space 20, portions 28 and 30 of portion 32 of the blind will be positioned between the elongated flat member and walls 12 and 14. When force is applied to fabric 16 as indicated by arrow 44, elongated member 22 will be urged to rotate so as to unravel portion 32 of blind 16. Since elongated member 22 cannot rotate within space 20, portions 28 and 30 will be pinched between the elongated flat member and side walls 12 and 14. This pinching action has the effect of resisting the fabric from being removed from hem bar 10.

The present invention has several advantages over the prior art. In particular, the elongated flat member 22 permit the fabric blind to be continuously bound to the bottom bar without the development of intermittent pressure points along the width of the fabric. This eliminates the scalloped look on the bottom edge of the blind. Furthermore, the bottom bar is quick and easy to mount onto the fabric blind and once mounted, the tightness of the pinching action between the edges of flat member 22 and side walls 12 and 14 leaves the bottom (hem) bar securely attached to the fabric.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A bottom bar for attachment to a lower edge of a window blind having a width, said bottom bar comprising:
a. An elongated tube having a length equal to the width of the window blind;
b. The elongated tube having first and second side walls separated by a space and an elongated slit extending along the entire elongated tube, the elongated slit communicating with the space, the elongated slit having a width;
c. An elongated flat member having an axis and a length equal to the width of the blind, the flat member having opposite first and second side edges, a width between the first and second side edges, and a thickness, the thickness of the elongated flat member being less than the width of the elongated slit, the width of the elongated flat member being dimensioned to be greater than the width of the slit while permitting the elongated flat member to fit entirely within the space;
d. The first and second side walls and the width of the elongated flat member being configured such that the elongated flat member cannot rotate about its axis when the elongated flat member is within the space, and
e. The lower edge of the window blind being wrapped around the elongated flat member.

2. The bottom bar of claim 1 wherein the elongated flat member has opposite first and second sides, the first side of the elongated flat member being adhered to the lower edge of the window blind.

3. The bottom bar of claim 2 wherein the lower edge of the window blind is adhered to the first side of the elongated flat member by an elongated strip of double sided adhesive tape.

4. The bottom bar of claim 1 wherein the elongated flat member and the first and second side walls of the elongated tube are configured such that a portion of the lower edge of the window blind which is wrapped around the elongated flat member is pinched between one of the first and second side edges of the elongated member and one of the first and second side walls when force is applied to the blind to drawn the lower edge of the blind out of the bottom bar.
